(19) United States
(12) Patent Application Publication
(10) Pub. No.: US 2008/0169725 A1
(43) Pub. Date: Jul. 17, 2008

(54) Piezoelectric actuation system

(76) Inventors: Shan-Yi Yu, Jhonghe City (TW); Han-Chang Liu, Jhonghe City (TW); Wen-Yu Tsai, Jhonghe City (TW)

Correspondence Address: BACON & THOMAS, PLLC, 625 SLATERS LANE, FOURTH FLOOR, ALEXANDRIA, VA, 22314, US

(21) Appl. No.: 11/652,569

(22) Filed: Jan. 12, 2007

(51) Int. Cl. H02N 2/06; B05B 12/06

(52) U.S. Cl. 310/316.01; 239/370

(57) ABSTRACT

This invention discloses a piezoelectric actuation system used for a nebulizer, and the system includes a frequency generator, a control interface and a piezoelectric actuator. The frequency generator generates at least one electric signal of a frequency value. The control interface is electrically connected to the frequency generator and provided for users to input or select an electric signal of the frequency generator, such that the frequency generator can issue an electric signal of a specific frequency value according to the input or selection of the control interface. Therefore, the piezoelectric actuator can receive the electric signal with the specific frequency value to produce a vibration of the best working frequency.

### BACKGROUND OF THE INVENTION

1. Field of the Invention

The present invention relates to a piezoelectric actuation system used in a nebulizer, and more particularly to a technical area of adding a control interface to drive a piezoelectric actuator.

2. Description of the Related Art

Referring to FIG. 1 for a schematic block diagram of a conventional piezoelectric actuation system used in a medical nebulizer, the piezoelectric actuation system 1 includes a processor 10, a frequency generator 11, a signal amplifier 12 and a piezoelectric actuator 13. The processor 10 generates a predetermined control signal 101 to the frequency generator 11, and then the frequency generator 11 issues an electric signal 121 of a predetermined frequency to the piezoelectric actuator 13 through the signal amplifier 12 according to the predetermined control signal 101. The piezoelectric actuator 13 receives the signal 121 of the predetermined frequency to produce a vibration to carry out a normal operation of the nebulizer.

Since the characteristics of components of the piezoelectric actuator 13 used in each nebulizer may vary, therefore a predetermined control signal 101, a predetermined frequency, or an electric signal 121 come with a factory default setting before the nebulizer exits the factory, or the piezoelectric actuator may deteriorate with time and require a fine-tune after the nebulizer exits the factory. Such arrangement assures that the piezoelectric actuator 13 of the nebulizer can be operated at the best working frequency.

Since the piezoelectric actuation system of a prior art cannot be adjusted manually anytime or fine-tuned instantly and automatically, and no appropriate protection warning or protection action can be provided when the nebulizer fails or operates abnormally, the inventor of the present invention based on years of experience on the research and development of a piezoelectric actuation system used in a nebulizer invents a piezoelectric actuation system for a nebulizer to overcome the aforementioned shortcomings.

### SUMMARY OF THE INVENTION

Therefore, it is a primary objective of the present invention to provide a piezoelectric actuation system used in a nebulizer, such that a better working frequency of a piezoelectric actuator can be adjusted manually or fine-tuned automatically for the nebulizer.

To achieve the foregoing objective, the present invention provides a piezoelectric actuation system comprising a frequency generator, a control interface and a piezoelectric actuator. The frequency generator generates at least one electric signal of a frequency value. The control interface is generally a key, a switch, a multi-slide switch or a rotating switch, and the control interface is electrically connected to the frequency generator and provided for users to input or select an electric signal provided by the frequency generator, and then the frequency generator issues an electric signal of a specific frequency value according to the input or selection of the control interface. Finally, the piezoelectric actuator receives the electric signal of the specific frequency value to produce a vibration of a better working frequency. It is noteworthy to point out that the frequency generator can send the electric signal of the specific frequency value to the piezoelectric actuator through a signal amplifying unit.

To achieve the foregoing objective, a piezoelectric actuation system of the invention comprises a processing unit, a frequency generator, a control interface and a piezoelectric actuator. The processing unit provides at least one control signal. The frequency generator is electrically connected to the processing unit for producing at least one electric signal of a frequency value. The control interface is also electrically connected to the processing unit for providing users to input or select the foregoing control signal, such that the frequency generator can issue an electric signal of a specific frequency value according to the control signal. The piezoelectric actuator receives the electric signal of such specific frequency to produce a vibration of a better working frequency. It is noteworthy to point out that the frequency generator can send the electric signal of the specific frequency value to the piezoelectric actuator through a signal amplifying unit. The control interface can be a key, a switch, a multi-slide switch or a rotating switch. The piezoelectric actuation system further comprises a feedback signal receiving unit and a protection unit. The feedback signal receiving unit is electrically connected to the processing unit and the piezoelectric actuator, so that the feedback signal receiving unit can receive a feedback electric signal produced by the piezoelectric actuator due to the electric signal, and then the processing unit receives the feedback electric signal transmitted from the piezoelectric actuator through the feedback signal receiving unit. Finally, the processing unit determines whether or not to start the protection unit according to the feedback electric signal and issue a protection warning or a protection action. The protection warning or protection action can be a display warning, a buzz warning, a power ON/OFF of the nebulizer, or a lamp indicating warning. The processing unit further issues an instant fine-tune control signal to the frequency generator according to the feedback electric signal automatically, so that the frequency generator can fine-tune an electric signal of a better frequency value for the piezoelectric actuator.

To make it easier for our examiner to understand the technical characteristics and effects of the present invention, we use preferred embodiments together with the attached drawings for the detailed description of the present invention.

### BRIEF DESCRIPTION OF THE DRAWINGS

FIG. 1 is a schematic block diagram of a conventional piezoelectric actuation system;

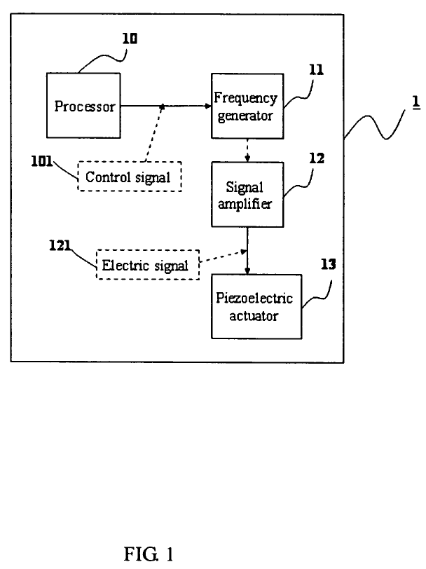

FIG. 2 is a schematic block diagram of a piezoelectric actuation system in accordance with a first preferred embodiment of the present invention;

FIG. 3 is a schematic block diagram of a piezoelectric actuation system in accordance with a second preferred embodiment of the present invention;

FIG. 4 is a schematic block diagram of a piezoelectric actuation system in accordance with a third preferred embodiment of the present invention;

FIG. 5 is a schematic block diagram of a piezoelectric actuation system in accordance with a fourth preferred embodiment of the present invention; and

FIG. 6 is a schematic block diagram of a piezoelectric actuation system in accordance with a fifth preferred embodiment of the present invention;

### DETAILED DESCRIPTION OF THE PREFERRED EMBODIMENTS

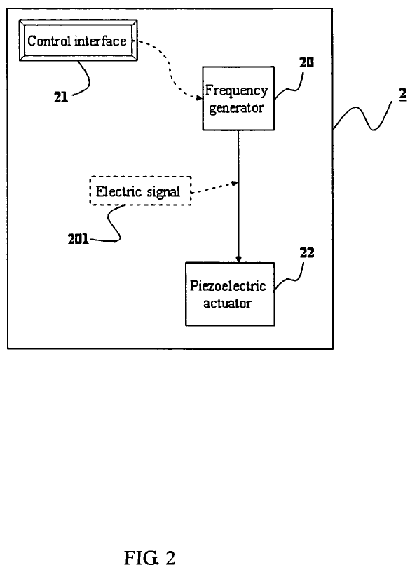

Referring to FIG. 2 for a schematic block diagram of a piezoelectric actuation system in accordance with a first preferred embodiment of the present invention, the piezoelectric actuation system 2 comprises a frequency generator 20, a control interface 21 and a piezoelectric actuator 22. The frequency generator 20 has an electric signal 201 of a plurality of frequencies, and the frequency generator 20 can issue an electric signal 201 of a specific frequency to the piezoelectric actuator 22 based on a setting. The piezoelectric actuator 22 generally needs to receive an electric signal 201 of a specific frequency (which is the working frequency) for a normal operation. The control interface 21 is generally a key, a switch, a multi-slide switch or a rotating switch electrically connected to the frequency generator 20 provided for users to input and select an electric signal 201 of the plurality of frequencies, so that the frequency generator 20 can issue an electric signal 201 of a better working frequency value to the piezoelectric actuator 22 according to the setup of the control interface 21.

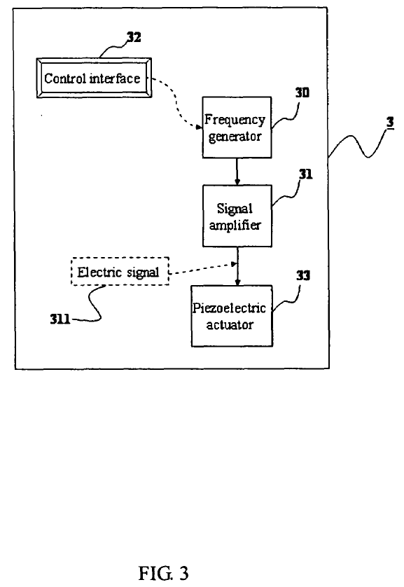

Referring to FIG. 3 for a schematic block diagram of a piezoelectric actuation system in accordance with a second preferred embodiment of the present invention, the piezoelectric actuation system 3 comprises a frequency generator 30, a signal amplifier 31, a control interface 32 and a piezoelectric actuator 33. The frequency generator 30 includes an electric signal 311 of a plurality of frequencies provided for users to select, and this frequency generator 30 can issue an electric signal 311 of a specific frequency to the piezoelectric actuator 33 through the signal amplifier 31. The piezoelectric actuator 33 generally needs to receive an electric signal 311 of the specific frequency (which is the working frequency) for a normal operation. The control interface 32 is generally a key, a switch, a multi-slide switch or a rotating switch electrically connected to the frequency generator 30 and provided for users to input or select the electric signal 311 provided by the frequency generator 30 through the signal amplifier 31. The frequency generator 30 can issue an electric signal 311 of a better working frequency value to the piezoelectric actuator 33 through the signal amplifier 31 according to the setup of the control interface 32.

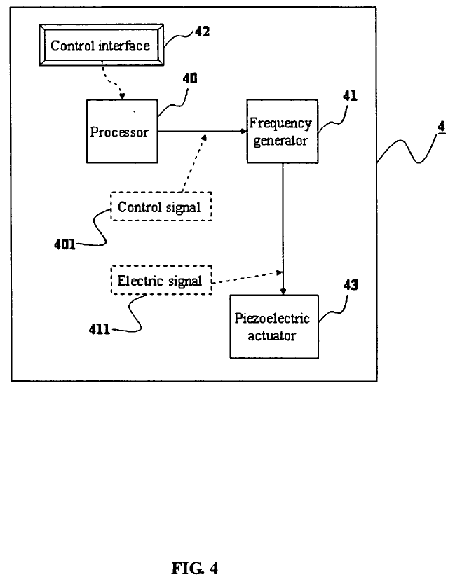

Referring to FIG. 4 for a schematic block diagram of a piezoelectric actuation system in accordance with a third preferred embodiment of the present invention, the piezoelectric actuation system 4 comprises a processor 40, a frequency generator 41, a control interface 42 and a piezoelectric actuator 43. The processor 40 has a plurality of control signals 401 provided for users to select, and the processor 40 can issue a specific control signal to the frequency generator 41 according to the user's selection. The frequency generator 41 is electrically connected to the processor 40, and the frequency generator 41 can issue an electric signal 411 of a specific frequency to the piezoelectric actuator 43 according to the foregoing specific control signal 401. The piezoelectric actuator 43 receives an electric signal 411 of the specific frequency (which is the working frequency) for a normal operation. In this embodiment, the control interface 42 can be a key, a switch, a multi-slide switch or a rotating switch electrically connected to the processor 40 and provided for users to input or select the foregoing specific control signal 401, such that the frequency generator 41 can issue an electric signal 411 of a better working frequency value to the piezoelectric actuator 43 according to the setup of the control interface 42.

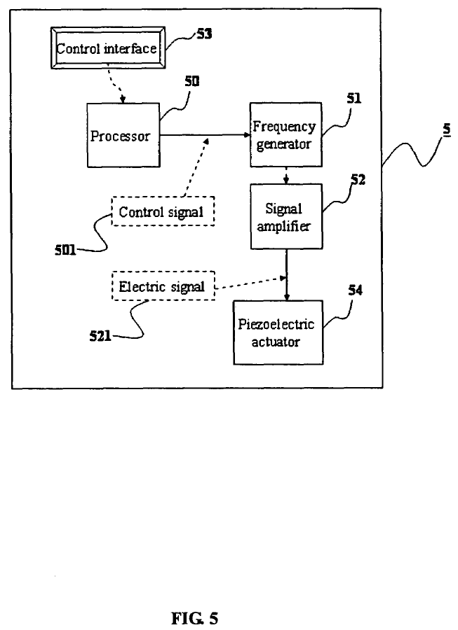

Referring to FIG. 5 for a schematic block diagram of a piezoelectric actuation system in accordance with a fourth preferred embodiment of the present invention the piezoelectric actuation system 5 comprises a processor 50, a frequency generator 51, a signal amplifier 52, a control interface 53 and a piezoelectric actuator 54. In this embodiment, the processor 50 is electrically connected to frequency generator 51, and the processor 50 has a plurality of control signals 501 provided for users to select. The frequency generator 51 is electrically connected to the signal amplifier 52, so that the frequency generator 51 can issue an electric signal 521 of a specific frequency to the piezoelectric actuator 54 through the signal amplifier 52. The piezoelectric actuator 54 usually receives the electric signal 521 of the specific frequency (which is the working frequency) for a normal operation. The control interface 53 can be a key, a switch, a multi-slide switch or a rotating switch, and the control interface 53 is electrically connected to processor 50 and provided for users to input or select the foregoing specific control signal 501. The frequency generator 51 issues an electric signal 521 of a better working frequency value to the piezoelectric actuator 54 through the signal amplifier 52 according to the setup of the control interface 53.

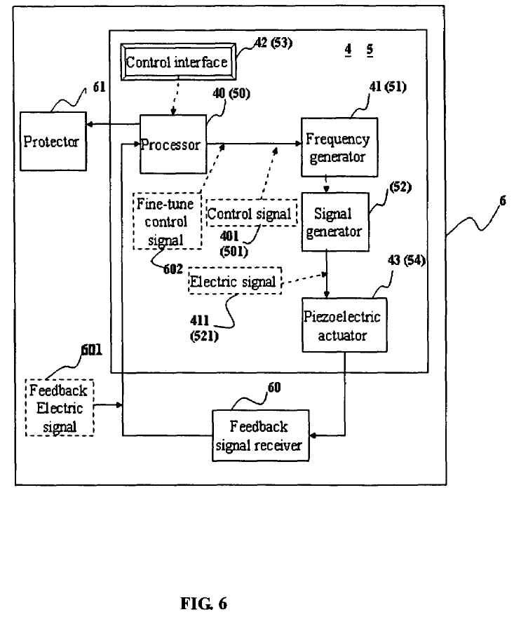

Referring to FIGS. 4 to 6 for schematic block diagrams of third, fourth and fifth preferred embodiments of the present invention, the piezoelectric actuation system 4, 5 further comprises a feedback signal receiver 60 and a protector 61. In this embodiment, the feedback signal receiver 60 is electrically connected to the processor 40, 50 and the piezoelectric actuator 43, 54, such that the feedback signal receiver 60 receives the electric signal 411, 521 from the piezoelectric actuator 43, 54 to produce a feedback electric signal 601, and then the processor 40, 50 receives a feedback electric signal 601 transmitted from the piezoelectric actuator 43, 54 through the feedback signal receiver 60. The processor 40, 50 confirms whether or not to start the protector 61 according to the feedback electric signal 601, so as to start a protection warning or a protection action. In this embodiment, the protection warning or protection action can be a display warning, a buzz warning, a power ON/OFF of the nebulizer or a lamp indicating warning. Further, the processor 40, 50 automatically issues an instant fine-tune control signal 602 to the frequency generator 41, 51 according to the feedback electric signal 601, such that the frequency generator 41, 51 can fine-tune an electric signal 411, 521 of a better frequency value for the piezoelectric actuator 43, 54.

While the invention has been described by means of specific embodiments, numerous modifications and variations could be made thereto by those skilled in the art without departing from the scope and spirit of the invention set forth in the claims.

1. A piezoelectric actuation system, used in a nebulizer, and said piezoelectric actuation system comprising:
a protection unit;
a frequency generator for generator at least one electric signal with a frequency value;
a control interface electrically connected to said frequency generator, and for inputting or selecting said electric signal, and said frequency generator issuing an electric signal with a specific frequency value according to an input or a selection of said control interface;
a piezoelectric actuator for receiving said electric signal with a specific frequency to produce a vibration;
a processing unit for detecting a feedback electric signal of said piezoelectric actuator for said protection unit to confirm whether a protection warning or a protection action is enabled, wherein said protection warning or protection action is a display warning, an audio signal, a power ON/Off of said nebulizer or a lamp indicating warning.

2. The piezoelectric actuation system of claim 1, wherein said frequency generator sends said electric signal to said piezoelectric actuator through a signal amplifying unit.

3. The piezoelectric actuation system of claim 1, wherein said control interface is a key, a switch, a multi-slide switch or a rotating switch.

4. A piezoelectric actuation system, used in a nebulizer, and said piezoelectric actuation system comprising:
a protection unit;
a processing unit for providing at least one control signal;
a frequency generator electrically connected to said processing unit, and for generating at least one electric signal with a frequency value;
a control interface electrically connected to said processing unit, and for inputting or selecting said control signal, such that said frequency generator can issue an electric signal with a specific frequency value according to said control signal;
a piezoelectric actuator for receiving said electric signal with a specific frequency value to produce a vibration; and
a processing unit detects a feedback electric signal of said piezoelectric actuator for said protection unit to confirm whether a protection warning or a protection action is enabled, wherein said protection warning or protection action is a display warning. an audio signal. a power ON/Off of said nebulizer or a lamp indicating warning.

5. The piezoelectric actuation system of claim 4, wherein said frequency generator sends said electric signal to said piezoelectric actuator through a signal amplifying unit.

6. The piezoelectric actuation system of claim 4, wherein said control interface is a key, a switch, a multi-side switch or a rotating switch.

7. The piezoelectric actuation system of claim 4, wherein said piezoelectric actuator generates a corresponding feedback electric signal according to said electric signal.

8. The piezoelectric actuation system of claim 7, wherein said processing unit receives said feedback electric signal transmitted from said piezoelectric actuator through a feedback signal receiving unit.

9. (canceled)

10. (canceled)

11. (canceled)

12. The piezoelectric actuation system of claim 7, wherein said processing unit automatically issues a fine-tune control signal of said frequency generator according to said feedback electric signal.
